(19) United States
(12) Patent Application Publication
(10) Pub. No.: US 2013/0076867 A1
(43) Pub. Date: Mar. 28, 2013

(54) IMAGING APPARATUS

(71) Applicant: Panasonic Corporation, Osaka (JP)

(72) Inventor: MIKIO SAKURAI, Osaka (JP)

(73) Assignee: PANASONIC CORPORATION, Osaka (JP)

(21) Appl. No.: 13/628,159

(22) Filed: Sep. 27, 2012

(30) Foreign Application Priority Data
Sep. 28, 2011 (JP) 2011-212097

(51) Int. Cl. H04N 13/02

(52) U.S. Cl. 348/47; 348/E13.074

(57) ABSTRACT

An imaging apparatus includes a first imaging unit configured to generate a first image, a second imaging unit configured to generate a second image, a detector configured to detect trigger information for start of shooting based on one of the first image and the second image, and a processor configured to perform a capturing process on both the first imaging unit and the second imaging unit when the detector detects the trigger information.

### BACKGROUND

1. Technical Field

The present disclosure relates to an exposing operation or a focus operation in a twin-lens imaging apparatus.

2. Related Art

Conventional twin-lens imaging apparatuses, which have two optical systems, can capture right and left images with binocular parallax, to record three-dimensional (3D) images, are known.

For example, JP 2010-252046 A discloses a twin-lens imaging apparatus that can detect a smile of a subject. Further, there are some twin-lens imaging apparatuses which can independently adjust focal lengths and field angles for each of right and left optical systems, and can individually capture right and left 2D images.

### SUMMARY

Right and left images captured by a twin-lens imaging apparatus have parallax. For this reason, in some cases, a face of a subject can be detected on one of the images but a subject is hidden and the face cannot be detected on the other of images. In such a case, even when a person's smile is detected from an image and an exposing operation and a focus operation are performed based on the detection result, a suitable process cannot be executed on right and left images, respectively.

For an imaging apparatus capable of adjusting field angles of right and left optical systems independently, when the field angles are set on the right and left optical systems, respectively, the above-described problem becomes particularly noticeable.

The present disclosure provides an imaging apparatus having a plurality of optical systems that can suitably perform a capturing operation or a focus operation on the respective optical systems.

In a first aspect, an imaging apparatus is provide, which includes a first imaging unit configured to generate a first image, a second imaging unit configured to generate a second image, a detector configured to detect trigger information for start of shooting based on one of the first image and the second image, and a processor configured to perform a capturing process on both the first imaging unit and the second imaging unit when the detector detects the trigger information.

In a second aspect, an imaging apparatus is provided, which includes a first imaging unit configured to generate a first image, a second imaging unit configured to generate a second image, a focus detector configured to detect a focus target according to a predetermined focus detecting process based on image information for one of the first image and the second image, and a processor configured to perform an autofocus process on both the first imaging unit and the second imaging unit based on the detection result of the focus target.

The above configuration enables the imaging apparatus of the present disclosure to perform the capturing process or the autofocus process when the trigger information or the focus target is detected in at least one of the plurality of optical systems. Thus, even though no trigger information or no focus target is detected in all of the plurality of optical systems, the imaging apparatus can suitably perform the capturing operation or the focus operation on each of the plurality of optical systems when the trigger information or the focus target is detected in at least one of the plurality of optical systems.

### BRIEF DESCRIPTION OF DRAWINGS

FIG. 1 is a block diagram illustrating electric configuration of a digital camera according to a first embodiment;

FIG. 2 is a flowchart illustrating an exposing operation of the digital camera according to the first embodiment;

FIGS. 3A1 to 3B2 are diagrams for describing detection of a face and determination of a smile in the digital camera according to the first embodiment;

FIG. 4 is a time chart illustrating the exposing operation of the digital camera according to the first embodiment;

FIG. 5 is a flowchart illustrating an AF operation of the digital camera according to a second embodiment; and

FIGS. 6A and 6B are diagrams for describing detection of a face in the digital camera according to the second embodiment.

### DETAILED DESCRIPTION OF EMBODIMENTS

Embodiments will be described in detail below with reference to the drawings. However, over-detailed description will be occasionally omitted. For example, detailed description about well-known items and duplicate description about substantially same components will be occasionally omitted. This is for avoiding the following description from being needlessly redundant, and for facilitating the understanding for those skilled in the art.

The inventors provide the accompanying drawings and the following description for sufficient understanding of the disclosure for those skilled in the art, and these drawings and the description are not intended to limit the subject matters recited in the claims.

### First Embodiment

A first embodiment will be described below with reference to the drawings.

### 1. Configuration of Digital Camera

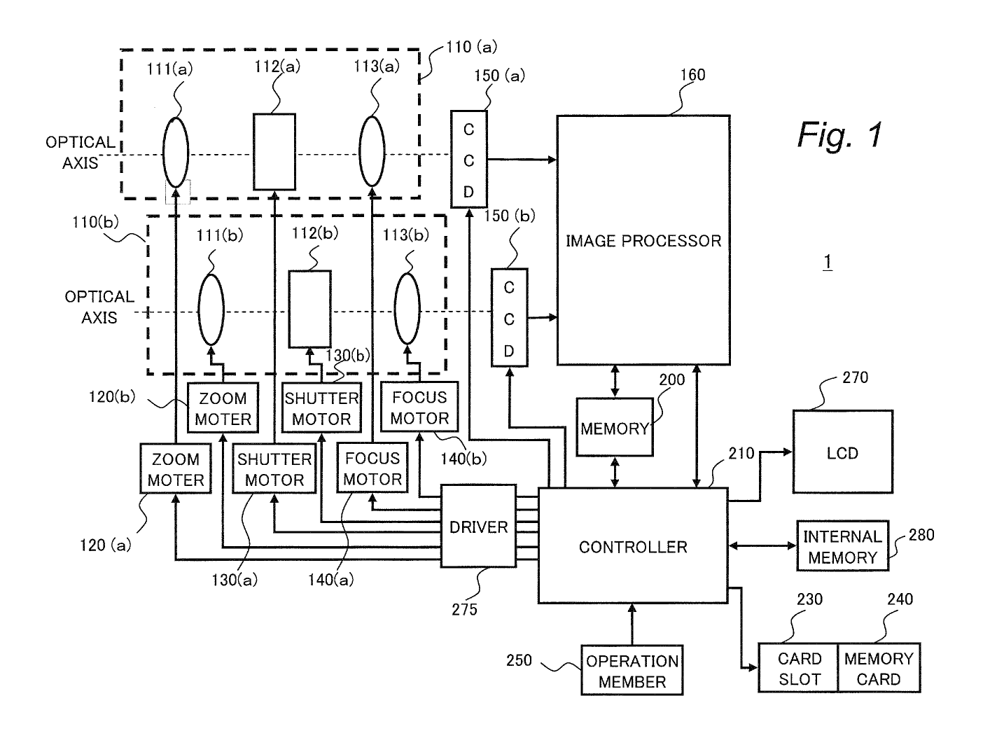

FIG. 1 is a block diagram illustrating an electric configuration of a digital camera 1 according to the embodiment.

The digital camera 1 includes optical systems 110(a) and 110(b), zoom motors 120(a) and 120(b), shutter motors 130(a) and 130(b), focus motors 140(a) and 140(b), CCD image sensors 150(a) and 150(b), an image processor 160, a memory 200, a controller 210, a card slot 230, an operation member 250, a liquid crystal monitor 270, and an internal memory 280.

The optical system 110(a) includes a zoom lens 111(a), a shutter with a diaphragm function (referred to as “diaphragm-lens shutter”) 112(a), and a focus lens 113(a). The optical system 110(b) includes a zoom lens 111(b), a shutter with a diaphragm function (referred to as “diaphragm-lens shutter”) 112(b), and a focus lens 113(b). The optical system 110(a) forms a subject image at a first view point, and the optical system 110(b) forms a subject image at a second view point different from the first view point. In a 3D shooting mode (detailed later), a left-eye image is formed based on the subject image formed by the optical system 110(a), and a right-eye image is formed based on the subject image formed by the optical system 110(b).

The zoom lenses 111(a) and 111(b) move along optical axes of the optical systems so as to be capable of enlarging or reducing the subject image imaged on the CCD image sensors 150(a) and 150(b), respectively. The zoom lenses 111(a) and 111(b) are controlled by the zoom motors 120(a) and 120(b), respectively and can perform shooting an image at the different focal lengths. Each of the diaphragm-lens shutters 112(a) and 112(b) has a lens shutter that is also a diaphragm mechanism for adjusting a light quantity. The diaphragm-lens shutters 112(a) and 112(b) are controlled by the diaphragm-shutter motors 130(a) and 130(b), respectively.

The focus lenses 113 (a) and 113 (b) move along the optical axes of the optical systems, so as to adjust focuses of the subject image imaged on the CCD image sensors 150(a) and 150(b), respectively. The focus lenses 113(a) and 113(b) are controlled by the focus motors 140(a) and 140(b), respectively.

Hereinafter, in some cases, the optical systems 110(a) and 110(b) are generally and simply described as the optical system 110. The above can be applied to the zoom lens 111, the diaphragm-lens shutter 112, the focus lens 113, the zoom motor 120, the diaphragm-shutter motor 130, the focus motor 140, and the CCD image sensor 150.

The zoom motors 120(a) and 120(b) drive and control the zoom lenses 111(a) and 111(b), respectively. The zoom motors 120(a) and 120(b) may be realized by pulse motors, DC motors, linear motors or servo motors. The zoom motors 120(a) and 120(b) may drive the zoom lenses 111(a) and 111(b) via cam mechanisms or mechanisms such as ball screws. Further, the zoom lens 111(a) and the zoom lens 111(b) may be configured to be controlled by the same operation.

The diaphragm-shutter motors 130(a) and 130(b) drive and control the diaphragm-lens shutters 112(a) and 112(b), respectively. The diaphragm-shutter motors 130(a) and 130(b) may be realized by pulse motors, DC motors, linear motors or servo motors. The diaphragm-shutter motors 130(a) and 130(b) may drive the diaphragm-lens shutters 112(a) and 112(b) via mechanisms such as cam mechanisms. Further, the diaphragm-lens shutters 112(a) 112(b) may be controlled by the same operation.

The focus motors 140(a) and 140(b) drive and control the focus lenses 113(a) and 113(b), respectively. The focus motors 140(a) and 140(b) may be realized by pulse motors, DC motors, linear motors or servo motors. The focus motors 140(a) and 140(b) may drive the focus lenses 113(a) and 113(b) via mechanisms such as cam mechanisms or ball screws.

A driver 275 generates and outputs signals for actually driving the zoom motor 120, the diaphragm-shutter motors 130 and the focus motors 140 according to a drive signal instructed from the controller 210.

The CCD image sensors 150(a) and 150(b) capture the subject images formed on the optical systems 110(a) and 110(b) to generate a first view point signal and a second view point signal. The CCD image sensors 150(a) and 150(b) perform respective operations such as exposure, transmission and electronic shutter.

The image processor 160 executes various processes on the first view point signal and the second view point signal generated by the CCD image sensors 150(a) and 150(b). The image processor 160 executes a process on the first view point signal and the second view point signal to generate image data to be displayed on the liquid crystal monitor 270 (hereinafter, “through images”) or generate image signals to be stored in a memory card 240. For example, the image processor 160 executes various image processes such as gamma correction, white balance correction and scratch correction on the first view point signal and the second view point signal.

The image processor 160 executes a cutting-out process on the first view point signal and the second view point signal in the 3D image process. If there is a difference in a vertical position between the first view point signal and the second view point signal in a 3D image, a viewer feels discomfort, but this difference can be reduced by correcting a cutting-out position in a vertical direction.

The image processor 160 compresses first view point signal and second view point signal subject to the aforementioned process according to a compressing format conforming to a predetermined file system standard. The compressed image signals obtained by compressing the first view point signal and the second view point signal are related to each other, and are recorded in the memory card 240. When image signals to be compressed are moving images, a moving image compressing standard such as H.264/MPEG4 AVC is applied. MPO file format images and JPEG images or MPEG moving images may be simultaneously recorded.

The image processor 160 can be realized by a DSP (Digital Signal Processor) or a microcomputer. Resolution (number of pixels) of through images may be set to resolution of the liquid crystal monitor 270. Alternatively, the resolution may be set to resolution of image data formed by compressing according to the compressing format conforming to a JPEG standard.

The memory 200 serves as work memories of the image processor 160 and the controller 210. The memory 200 temporarily stores, for example, image signals processed by the image processor 160 or image data input from the CCD image sensors 150 before the process by the image processor 160. Further, the memory 200 temporarily stores shooting conditions of the optical systems 110 and the CCD image sensors 150 at the time of shooting. The shooting conditions include a subject distance, field angle information, ISO sensitivity, a shutter speed, an EV value, an F value, a lens-to-lens distance, a shooting time, and/or an OIS (Optical Image Stabilizer) shift amount. The memory 200 can be realized by, for example, a DRAM or a ferroelectric memory.

The internal memory 280 is composed of a flash memory or a ferroelectric memory. The internal memory 280 stores a control program for controlling the digital camera 1 entirely, and so on.

The controller 210 is a control unit for controlling the digital camera 1 entirely. The controller 210 may be composed of hardware alone, or may be realized by a combination of hardware and software. The controller 210 can be realized by a microcomputer or the like.

The card slot 230 can be loaded with the memory card 240 therein. The card slot 230 can be mechanically and electrically connected to the memory card 240.

The memory card 240 contains a flash memory or a ferroelectric memory, and can store data.

The operation member 250 is a general name of a user interface that receives user's operations. For example, the operation member 250 has an operating dial and a recording start button that receive operations from the user.

The liquid crystal monitor 270 is a display device that can perform 2D-display or 3D-display with the first view point signal and the second view point signal which are generated by the CCD image sensors 150 or read from the memory card 240. The liquid crystal monitor 270 can display various setting information about a digital camera 100. For example, the liquid crystal monitor 270 can display an EV value, an F value, a shutter speed, and ISO sensitivity that are the shooting conditions at the time of shooting.

### 2. Operation of Digital Camera

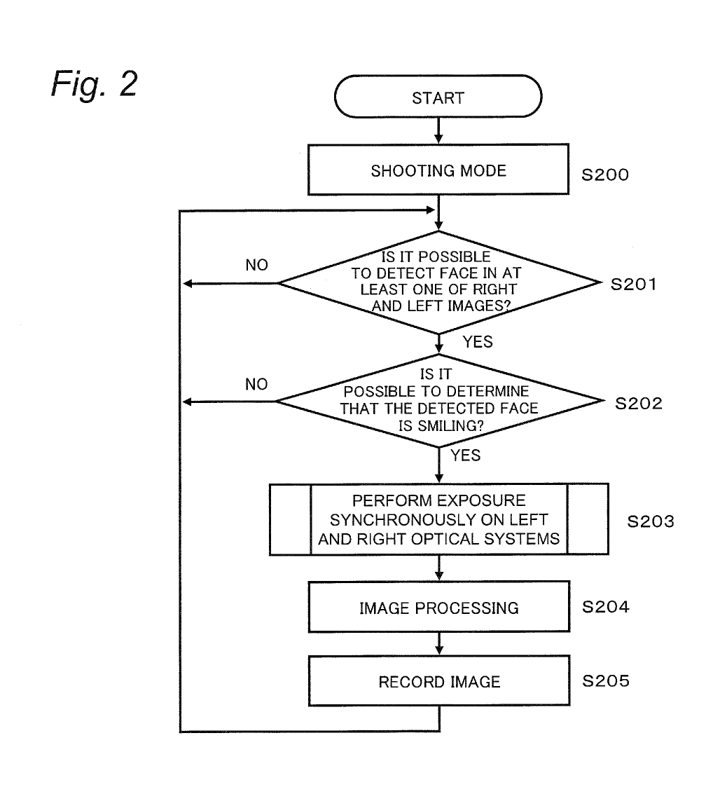

The operation of the digital camera 1 according to the first embodiment will be described below with reference to the drawings. FIG. 2 is a flowchart illustrating an exposing operation of the digital camera 1 according to the first embodiment. At a start point of the process shown in the flowchart of FIG. 2, the digital camera 1 completes preparation for the shooting an image such as a power-on operation.

The image processor 160 starts to generate through images based on images generated by the CCD image sensors 150(a, b), and the controller 210 starts to display the through images on the liquid crystal monitor 270. As a result, the digital camera 1 enters a shooting mode (S200).

Entering the shooting mode (S200), the user can determine one from various shooting modes on a menu screen displayed on the liquid crystal monitor 270. The various shooting modes include a 3D shooting mode, a 2D image TELE/WIDE simultaneous shooting mode, and a moving image/still image simultaneous shooting mode.

The 3D shooting mode is a mode for shooting a 3D image that enables a stereoscopic view. In this mode, the optical system 110(a) captures a left-eye image, and the optical system 110(b) captures a right-eye image to generate a 3D image.

The 2D image TELE/WIDE simultaneous shooting mode is a mode for simultaneously capturing two 2D images via the right and left optical systems 110(a, b). In the 2D image TELE/WIDE simultaneous shooting mode, focal lengths (zoom magnification) of the right and left optical systems 110(a, b) can be adjusted independently. For example, the focal length of the optical system 110(a) can be adjusted to 100 mm, and the focal length of the other optical system 110(b) is adjusted to 25 mm, respectively. Further, in the 2D image TELE/WIDE simultaneous shooting mode, the right and left optical systems 110(a, b) can perform an autofocus (AF) operation independently.

The moving image/still image simultaneous shooting mode is a mode for enabling a moving image and a still image (2D image) of one subject to be shot simultaneously. In the moving image/still image simultaneous shooting mode, the CCD image sensor 150(a) is driven into a drive mode for shooting a moving image, while, the CCD image sensor 150(b) is driven in a drive mode for shooting a still image.

In the following description, the user selects the 2D image TELE/WIDE simultaneous shooting mode. At this time, the focal lengths of the right and left optical systems 110(a) and 110(b) in the digital camera 1 are set to the TELE end (for example, the focal length is 100 mm) and the WIDE end (for example, the focal length is 25 mm), respectively.

Further, when the digital camera 1 enters the shooting mode, the user can carry out various shutter settings on the menu screen displayed on the liquid crystal monitor 270 besides the setting of the various shooting modes. The various shutter settings include a smile detecting shutter mode, a blink detecting shutter mode, and a shutter mode for releasing a shutter after a predetermined time passes from the detection of a face. A smile detecting shutter mode is a mode for releasing a shutter when a determination is made that a person included in a photographed image is smiling. The blink detecting shutter mode is a mode for releasing the shutter when a determination is made that a person included in a photographed image does not blink to close his/her eyes after the release is pushed. In the following description, the smile detecting shutter mode is selected.

For convenience of the following description, the optical system 110(a) and the CCD 150(a) are called “the left optical system” and “the left CCD”, respectively. The optical system 110(b) and the CCD 150(b) are called “the right optical system” and “the right CCD”, respectively. Further, an image generated via the left optical system 110(a) and the left CCD 150(a) is called “a left image”, and an image generated via the right optical system 110(b) and the right CCD 150(b) is called “a right image”.

When the digital camera 1 is in a state capable of shooting an image, the image processor 160 executes a face detecting operation on right and left images based on image data output from the CCD image sensors 150(a) and 150(b) at real time (S201). When no face is detected on both the right and left images (NO at S201), the image processor 160 continues the face detecting process.

On the other hand, when the determination is made that a face can be detected on at least one of the right and left images (YES at S201), the controller 210 goes to a smile determining process (S202). The image processor 160 executes a smile detecting operation on the detected face image (S202). When the smile cannot be detected (NO at S202), the face detecting process is again executed (S201).

On the other hand, when the determination is made that a smile is detected on the detected face image (YES at S202), the controller 210 executes the exposing operation (S203).

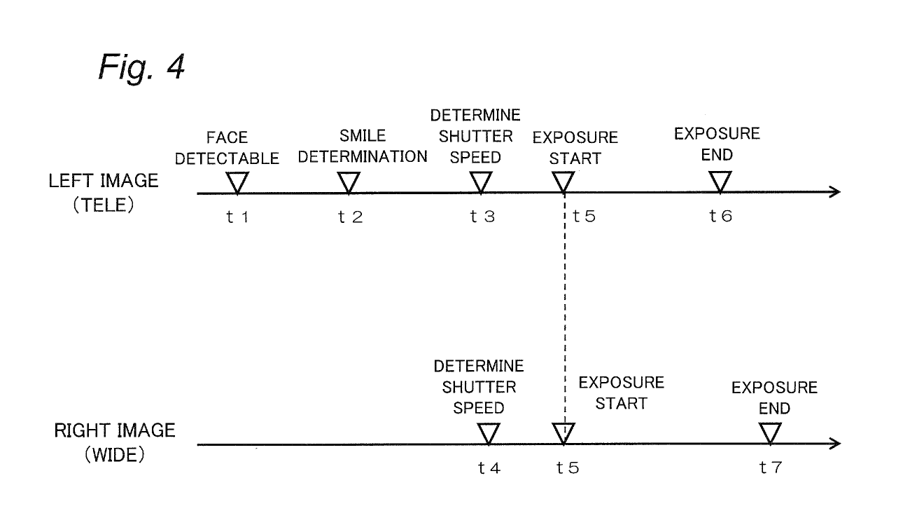

Specifically, when smile information is detected on at least any of the right and left images, which is used as a trigger, a capturing operation is performed on both the right and left CCDs 150(a, b) (S203). For example, when no smile nor a face can be detected from the image captured via the right optical system 110(b) but a face or a smile can be detected from the image captured via the left optical system 110(a), the controller 210 allows both the right and left CCDs 150(a, b) to perform the capturing operation. That is to say, in this case, synchronized shooting can be carried out in the right and left optical systems based on the fact that a smile is detected on the left image even though a smile is not detected on the right image. A timing chart of this will be described later (FIG. 4).

When the exposing operation is completed, the image processor 160 executes processes such as y correction, white balance correction, and a compressing process on the images generated by the right and left CCD image sensors 150(a, b) (S204). The controller 210 records right and left image data subjected to the compressing processes into the memory card 240 (S205).

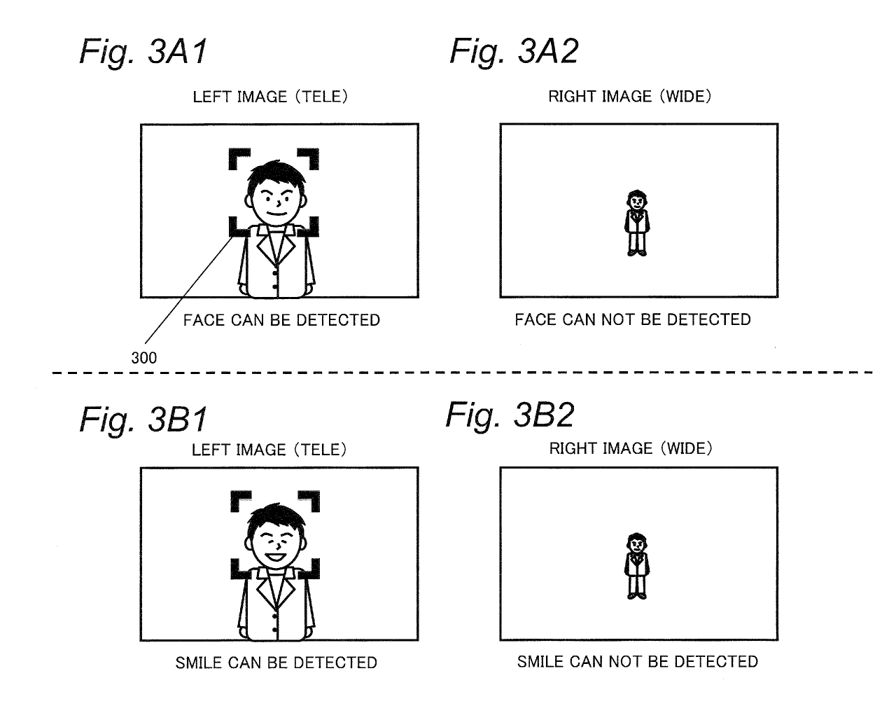

FIGS. 3(A1) to 3(B2) are diagrams describing the face detection and smile determination in the digital camera 1 according to the first embodiment. Particularly, those drawings are provided for describing the face detecting operation and the smile determining operation in 2D images captured with the focal lengths of the right and left optical systems 110(a, b) being different from each other.

FIG. 3A1 illustrates the left image, and the focal length is set to the TELE end (100 mm). FIG. 3A2 illustrates the right image captured simultaneously with the image shown in FIG. 3A1, and the focal length is set to the WIDE end (25 mm). As shown here, although the same subject is captured in right and left optical systems, the left image (see FIG. 3A1) is captured at the TELE end, and thus the subject image is large and a face is easily detected in the left image. In this case, the controller 210 can set a face detection frame 300 for the left image.

However, since the right image (see FIG. 3A2) is captured at the WIDE end, in the right image, the subject image is small and the face detection is more difficult as compared to the case of the shooting TELE end. In this case, the controller 210 cannot set the face detection frame 300 for the right image. In this embodiment, in the 2D shooting where the focal lengths are different between the right and left optical systems, the right image for which the face detection frame 300 cannot be set can be started to be shot approximately simultaneously with the left image via a face detection signal, as a trigger, of the left image (see FIG. 3A1) where a face can be detected.

FIG. 3B1 is a diagram in a case where a smile of a subject is detected in the shooting under the same shooting conditions as those in FIG. 3A1. On the left image shown in FIG. 3B1, a face can be detected due to the shooting at the TELE end, and a smile can be detected based on the detected face information. However, in FIG. 3B2, due to the shooting at the WIDE end, even when the subject is a smile, it is difficult to analyze the look of the subject face. For this reason, the smile cannot be detected.

In this embodiment, a control is made so that the shooting is approximately simultaneously started on both the left image (see FIG. 3B1) and the right image (see FIG. 3B2) based on the smile information detected on the left image (see FIG. 3B1). As a result, a shooting start trigger can be given also to the image (see FIG. 3B2) photographed at the WIDE end where a face is not detected based on the smile information, so that synchronized shooting can be carried out at both the focal lengths at the TELE end and the WIDE end.

FIG. 4 is a time chart illustrating the exposing operation of the digital camera 1 according to the first embodiment.

In FIG. 4, similarly to the above description, a left image is captured at the TELE end, and a right image is captured at the WIDE end. As to a time axis, time passes from left to right in the drawing. The smile detecting shutter mode for performing the exposing operation that synchronizes with detection of a smile is set.

At time t1, the controller 210 detects face information based on the left image. At this time, face information cannot be detected on the right image.

At time t2, the controller 210 can detect smile information based on the left image where the face information is detected. The shooting operation is started to be performed by the detection of the smile information.

To enter the shooting operation, the digital camera 1 sets the exposure and the shutter speed based on the right and left image information at times t3 and t4. Although the exposure, the shutter speed, and so on are set based on the right and left image information, the information of one of the right and left images in which the smile information is detected may be applied to the other image or vice versa (in other words, the exposure conditions may be the same or different between the right and left images).

At time t5, electronic front curtains of the right and left CCDs 150(a, b) are started in order to start the exposure. In order to capture a subject on the right and left sides at the same timing, the right shooting and left shooting are approximately simultaneously carried out in synchronous with each other.

At time t6, the controller 210 controls the left lens shutter 112(a) to shut according to a shutter speed set for the left optical system 110(a). Similarly, at time t7, the controller 210 controls the right lens shutter 112(b) to shut according to a shutter speed set for the right image. In this manner, the right and left images can be approximately simultaneously shot by using, as a trigger, the detected smile information on the left image where a smile can be detected.

It is desirable that the exposure is started simultaneously on the right and left sides, but a time lag that does not affect the exposure time, for example, the time lag within a range of about ½ of the shutter speed, may be considered as an approximately simultaneous range.

### 3. Effect, and So On

The digital camera 1 according to the first embodiment includes the optical system 110(a) and the CCD 150(a) for generating a left image, the optical system 110(b) and the CCD 150(b) for generating a right image, and the controller 210 for detecting trigger information (face detection) for start of shooting based on one of a left image and a right image. When detecting trigger information, the controller 210 performs the capturing processes (exposing operation, setting of the shutter speed, capturing operation, and so on) on both the right and left optical systems 110(a, b) and the CCDs 150(a, b).

In the first embodiment, when trigger information for start of shooting is obtained from one of a right and a left image, the shooting process is executed on both right and left images. With this arrangement, when the right and left optical systems are driven independently, the shooting operation can be started on both the right and left images securely based on the trigger information about start of shooting.

### Second Embodiment

The second embodiment describes an autofocus (AF) operation in a case where the AF operations are performed independently for the right and left optical systems 110(a) and 110(b) of the digital camera 1.

Since an electric configuration of the digital camera 1 according to the second embodiment is similar to that in the first embodiment described with reference to FIG. 1, description thereof is omitted.

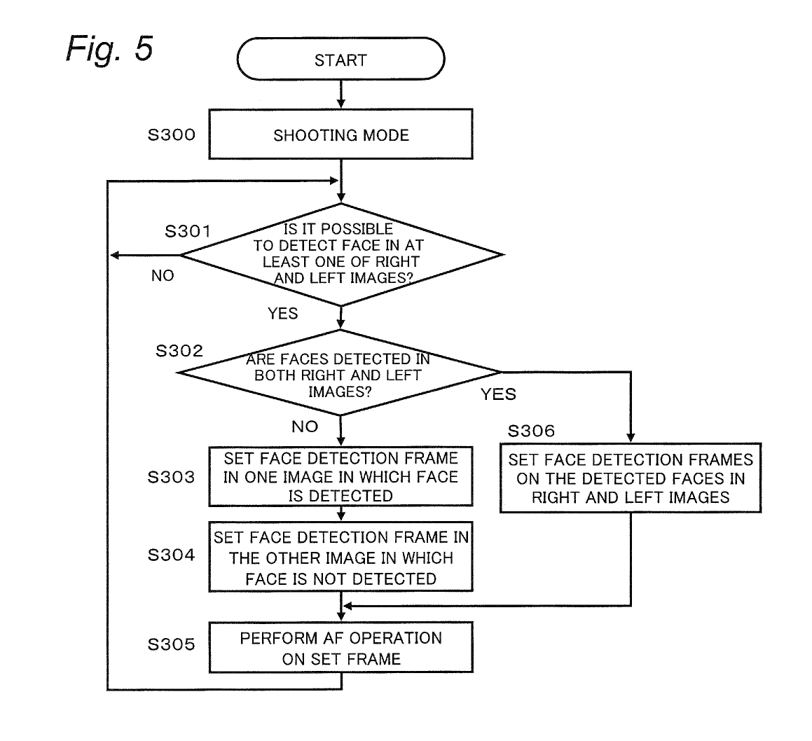

FIG. 5 is a flowchart illustrating the AF operation of the digital camera 1 according to the second embodiment.

At a starting point of the process in FIG. 5, the preparation for shooting an image such as powering-on operation in the digital camera 1 is completed. The image processor 160 starts to generate through images based on the images generated by the CCD image sensors 150(a, b), and the controller 210 starts to display the through images on the liquid crystal monitor 270. As a result, the digital camera 1 enters the shooting mode.

When entering the shooting mode (S300), the user can determine one mode to be adopted from the various shooting modes on the menu screen displayed on the liquid crystal monitor 270. In the following description, the user selects the 2D TELE/WIDE simultaneous shooting mode. At this time, the focal lengths of the right and left optical systems 110(a, b) in the digital camera 1 are set to the TELE end (for example, the focal length is 100 mm) and the WIDE end (for example, the focal length is 25 mm).

When the digital camera 1 is in a state capable of capturing (shooting) an image, the image processor 160 executes the face detecting operation on the right and left images based on image data output from the CCD image sensors 150(a, b) at real time (S301).

When a face cannot be detected on at least one of the right and left images (NO at S301), the image processor 160 continues the face detecting process.

On the other hand, when the determination is made that a face can be detected on at least one of the right and left images (YES at S301), the image processor 160 executes a face detection frame setting process on the detected image (S302). The face detection frame setting process is a process for drawing a detection frame (“face detection frame” or “focus frame”) so as to be superimposed on the through image displayed on the liquid crystal monitor 270 and surround the detected face. By referring to the face detection frame, the user can confirm that a face is detected.

Specifically, a determination is made whether a face is detected on both the right and left images (S302). When the face is detected on both the right and left images (YES at S302), the image processor 160 sets the face detection frame on both the right and left images based on a region of the detected face (S306).

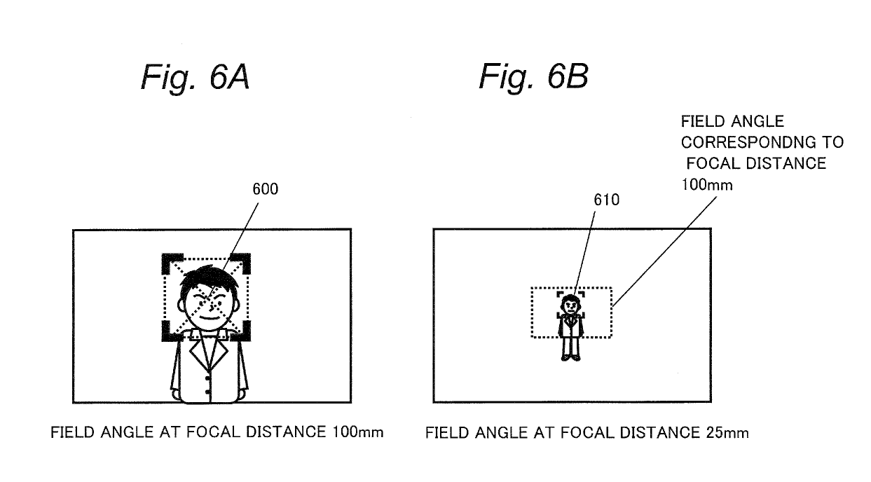

On the other hand, when a face is detected on either one of the right and left images (NO at S302), the image processor 160 sets the face detection frame on the image where a face is detected (S303). Further, the image processor 160 sets the face detection frame also on the image where a face is not detected (S304). The face detection frame setting process at this step 5304 will be described in detail later with reference to FIGS. 6A and 6B. In this manner, the face detection frame of the image where a face cannot be displayed can be displayed based on at least one of the right and left face detection information. That is to say, the face detection frame can be simultaneously displayed on the right and left images.

Thereafter, the controller 210 performs the AF operation on the image regions of the right and left images where the face detection frames are set, respectively (S305). Specifically, while the focus lenses 113(a, b) are being moved from a wide side to a telephoto side or vice versa, a peak position of a contrast value of the image regions indicated by the face detection frames set on the right and left images is determined based on a change in the contrast value so that the AF operation is performed. The AF operation is performed on the right and left images independently, but the AF operation may be performed on either one of the right and left images based on AF information about the other image (conforming with the other AF information).

A method for setting the face detection frame on one of the right and left images based on the face detected result of the other image (S304) will be described with reference to FIGS. 6A and 6B. As one example, an operation for setting the face detection frame on the right image based on the face detected result of the left image when a face cannot be detected on the right image will be described. FIGS. 6A and 6B are diagrams for describing the face detection in the digital camera 1 according to the second embodiment.

FIG. 6A is a diagram illustrating a captured image at the MLR end, for example, at a field angle corresponding to the focal length of 100 mm. FIG. 6B is a diagram illustrating a captured image at the WIDE end, for example, at a field angle corresponding to the focal length of 25 mm. A broken line in FIG. 6B indicates a region corresponding to a whole region of the image shown in FIG. 6A.

It is assumed that in the image shown in FIG. 6A, a subject image is large and thus the image processor 160 can detect a face. At this time, the controller 210 knows a position of the detected face (or the face detection frame) on the display region. The controller 210 superimposes and displays the face detection frame 600 on a through image for the left image so as to surround the detected face.

When the face detection frame in FIG. 6B is displayed based on the information obtained in FIG. 6A, since the controller 210 knows the information about the right and left focal lengths, the controller 210 detects, in the image at the WIDE end shown in the FIG. 6B, a position of a region (the region indicated by the broken line) corresponding to field angle in FIG. 6A as the image at the TELE end, and calculates a relative position of the face detection frame 610 in that region. The controller 210 then superimposes and draws the face detection frame 610 on the through image for the right image so that the face detection frame 610 is displayed on the calculated position.

For this process, a size of the face detection frame is changed according to a ratio between the focal length at the TELE end and the focal length at the WIDE end.

For example, as in the second embodiment, when the focal length of the left image is 100 mm and the focal length of the right image is 25 mm, the size of the face detection frame displayed on the through image for the right image (focal length is 25 mm) is about 1/16 of the face detection frame displayed on the through image for the right image (focal length is 100 mm).

The digital camera 1 according to the second embodiment includes the optical system 110(a) and the CCD 150(a) for generating a left image, the optical system 110(b) and the CCD 150(b) for generating a right image, and the controller 210 for detecting a focus target according to a predetermined focus detecting process based on the image information about either one of the left image and right image. The controller 210 executes the autofocus process on both the right and left optical systems 110(a, b) and the CCDs 150(a, b) based on the detected result of the focus target.

In the second embodiment, the autofocus process is executed on both the right and left optical systems based on the detected result of the focus target on either one of the right and left images. Hence, when the right and left optical systems are driven independently and even when the focus target cannot be detected on only one of the right and left images, the autofocus process can be executed securely on both the right and left optical systems.

### Other Embodiments

As an illustration of a technique disclosed in the present invention, the first and second embodiments are described. However, the disclosed technique is not limited to this, and thus it can be applied to embodiments where change, replacement, addition and omission are suitably carried out. Further, the components described in the first and second embodiments may suitably be combined so that a new embodiment will be provided. Therefore, other embodiments will be illustrated below.

In FIG. 1 describing the first embodiment, the CCD is described as the imaging device, but another imaging device such as an MOS sensor may be used to carry out capturing of an image.

In FIG. 2 describing the first embodiment, the focal lengths are set at the TELE end and the WIDE end, but the focal length is not limited to them. Any focal lengths may be set in the right and left optical systems, respectively. Further, a correspondence of the TELE side and the WIDE side to the right and left optical systems may be switched.

In FIG. 5 describing the second embodiment, the controller 210 sets the right and left face detection frames independently after the respective completion of calculations for right and left images, but the embodiment is not limited to this. That is to say, the controller 210 may wait for the completion of both the calculations for the right and left images and then display the right and left face detection frames.

The above embodiments illustrate the example where the detection of the trigger information for the start of shooting or the detection of a focus target are carried out based on a result of detecting a human face, but the embodiment is not limited to them. That is to say, the embodiment can be applied also to other detection such as detection of pets (dogs and cats) and detection of baby of human being.

The above embodiments illustrate the examples where the face detection frame which is square is displayed, but the frame is not limited to this. The face display frame having shape other than the square shape may be displayed, or the face display frame does not have to be displayed.

The above embodiments describe the exposing function using the detection of a person's smile as the trigger information for start of shooting, but other video signals of blink detection and baby or pet detection which causes a shutter to be automatically released when the baby or the pet faces front may be used as trigger signals. Further, the trigger signal used for the exposure is not limited to a video signal. A signal other than a release button, such as a touch shutter signal of a live view image on one of the right and left images, may be used.

The digital camera 1 of this disclosure can suitably perform the capturing operation or the focus operation in the right and left optical systems, respectively. As the illustration of the technique in this disclosure, the embodiments are described. For this reason, the accompanying drawings and the detailed description are provided.

Therefore, the components described in the accompanying drawings and the detailed description include not only the components required for solving the problem but also components that are not required for solving the problem in order to illustrate the above technique. For this reason, these non-essential components should not be immediately granted as being required due to disclosure of these non-essential components in the accompanying drawings and the detailed description.

Since the above embodiments illustrate the disclosed technique, change, replacement, addition and omission can be variously carried out in the claims or its equivalent scope.

### INDUSTRIAL APPLICABILITY

The concept of the present disclosure is not limited to the application for the digital camera. That is to say, the concept may be applied to lens interchangeable cameras, digital video cameras, or mobile devices such as mobile phones with camera function and smart phones.

What is claimed is:

1. An imaging apparatus comprising:
a first imaging unit configured to generate a first image;
a second imaging unit configured to generate a second image;
a detector configured to detect trigger information for start of shooting based on one of the first image and the second image; and
a processor configured to perform a capturing process on both the first imaging unit and the second imaging unit when the detector detects the trigger information.

2. The imaging apparatus according to claim 1, further comprising:
an adjusting unit configured to adjust focal lengths of the first imaging unit and the second imaging unit independently,
wherein the detector detects the trigger information based on one of the first image and the second image that is generated by the imaging unit having longer focal length.

3. The imaging apparatus according to claim 1, wherein the processor approximately simultaneously carries out exposure operation for the first imaging unit and the second imaging unit when the capturing process is executed.

4. An imaging apparatus, comprising:
a first imaging unit configured to generate a first image;
a second imaging unit configured to generate a second image;
a focus detector configured to detect a focus target according to a predetermined focus detecting process based on image information for one of the first image and the second image; and
a processor configured to perform an autofocus process on both the first imaging unit and the second imaging unit based on the detection result of the focus target.

5. The imaging apparatus according to claim 4, further comprising:
a first adjusting unit configured to adjust a focal length of the first imaging unit; and
a second adjusting unit configured to adjust a focal length of the second imaging unit independently of the first imaging unit,
wherein the detector detects a focus target according to the predetermined focus detecting process based on image information for one of the first image and the second image which is generated by the imaging unit having longer focal length.

6. The imaging apparatus according to claim 5, wherein the detector detects a focus target for one of the first image and the second image which is generated by the imaging unit having shorter focal length, based on a focus target detected from the other of the first image and the second image which is generated by the imaging unit having longer focal length.
